(19) United States
(12) Patent Application Publication
(10) Pub. No.: US 2019/0359862 A1
(43) Pub. Date: Nov. 28, 2019

(54) ELECTRICALLY CONDUCTIVE ADHESIVE LAYER

(71) Applicant: 3M INNOVATIVE PROPERTIES COMPANY, St. Paul, MN (US)

(72) Inventors: Jing Fang, Shanghai (CN); Dong Yang, Shanghai (CN); Jeffrey W. McCutcheon, Baldwin, WI (US); Hua Zhang, Guangzhou (CN)

(21) Appl. No.: 16/239,122

(22) Filed: Jan. 3, 2019

(30) Foreign Application Priority Data
May 28, 2018 (CN) 201820801617.7

(51) Int. Cl. C09J 9/02; H01B 1/24; H01B 1/22; C09J 7/38; C09J 7/21; C09J 7/28; C09J 7/29

(52) U.S. Cl. CPC C09J 9/02; H01B 1/24; H01B 1/22; C09J 7/38; C09J 7/385; C09J 2400/163; C09J 7/28; C09J 7/29; C09J 2203/326; C09J 2433/00; C09J 7/21

(57) ABSTRACT

An electrically conductive adhesive layer including an adhesive material and a plurality of substantially plate-like nickel-coated graphite particles dispersed uniformly in the adhesive material is described. The adhesive layer has an average thickness in a range from 10 microns to 100 microns, and an electrical resistance in a thickness direction of less than 200 milli ohms. A ratio of a total weight of the graphite particles to a total weight of the adhesive layer is from 20% to 50%.

### BACKGROUND

Adhesives have been used for a variety of marking, holding, protecting, sealing and masking purposes. Adhesives may include electrically conductive particles in order to reduce the electrical resistance of the adhesive.

### SUMMARY

In some aspects of the present description, an electrically conductive adhesive layer including an adhesive material and a plurality of substantially plate-like nickel-coated graphite particles dispersed uniformly in the adhesive material is provided. The adhesive layer has an average thickness in a range from 10 microns to 100 microns, and an electrical resistance in a thickness direction of less than 200 milli ohms. A ratio of a total weight of the graphite particles to a total weight of the adhesive layer is from 20% to 50%.

In some aspects of the present description, an electrically conductive adhesive layer having an average thickness in a range from 10 microns to 100 microns and including an adhesive material and a plurality of substantially plate-like nickel-coated graphite particles dispersed uniformly in the adhesive material at a sufficiently high concentration so that the adhesive layer has an electrical resistance in a thickness direction of less than 200 milli ohms is provided. At least some of the nickel-coated graphite particles are sufficiently sharp such that when the electrically conductive adhesive layer is adhered to a conductive surface comprising an insulative layer disposed thereon, where the insulative layer has a thickness in a range from 10 nm to 100 nm, at least some of the nickel-coated graphite particles proximate the conductive surface penetrate the insulative layer to electrically connect with the conductive surface.

### BRIEF DESCRIPTION OF THE DRAWINGS

FIG. 1 is a schematic cross-sectional view of an article including an electrically conductive adhesive layer;

FIG. 2 is a schematic top view of a substantially plate-like nickel-coated graphite particle;

FIG. 3 is a schematic cross-sectional view of an electrical assembly including an electrically conductive adhesive layer; and

FIG. 4 is a schematic cross-sectional view of a multilayer adhesive film.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Adhesive layers of the present description include electrically conductive particles dispersed in an adhesive material. A wide variety of adhesive materials known in the art are useful in the adhesive layers of the present description. An adhesive material may be or include one or more of an acrylate, a methacrylate, an epoxy, a polyurethane, a polyester, a urethane, a polycarbonate, and a polysiloxane. An adhesive material may be or include one or more of a pressure sensitive adhesive, a hot melt adhesive, a thermoset adhesive, a thermoplastic adhesive, an ultraviolet (UV) adhesive, a liquid adhesive, a solvent based adhesive, and a water based adhesive. An adhesive material may include a tackifier for increasing the tack or stickiness of the adhesive. Suitable tackifiers include C5 hydrocarbons, C9 hydrocarbons, aliphatic resins, aromatic resins, terpenes, terpenoids, terpene phenolic resins, rosins, rosin esters, and combinations thereof. The conductive particles are preferably substantially plate-like nickel-coated graphite particles such as those available from Oerlikon Metco (Switzerland). It has been found that utilizing substantially plate-like nickel-coated graphite particles provide improved conductivity on certain metal surfaces such as nickel or stainless steel.

An example of an adhesive is a pressure-sensitive adhesive. Pressure-sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure-sensitive adhesives are polymers designed and formulated to exhibit the requisite viscoelastic properties resulting in a desired balance of tack, peel adhesion, and shear holding power. Useful acrylic pressure sensitive adhesives are described in U.S. Pat. Appl. Pub. Nos. US 2009/0311501 (McCutcheon et al.) and US 2014/0162059 (Wan et al.), for example.

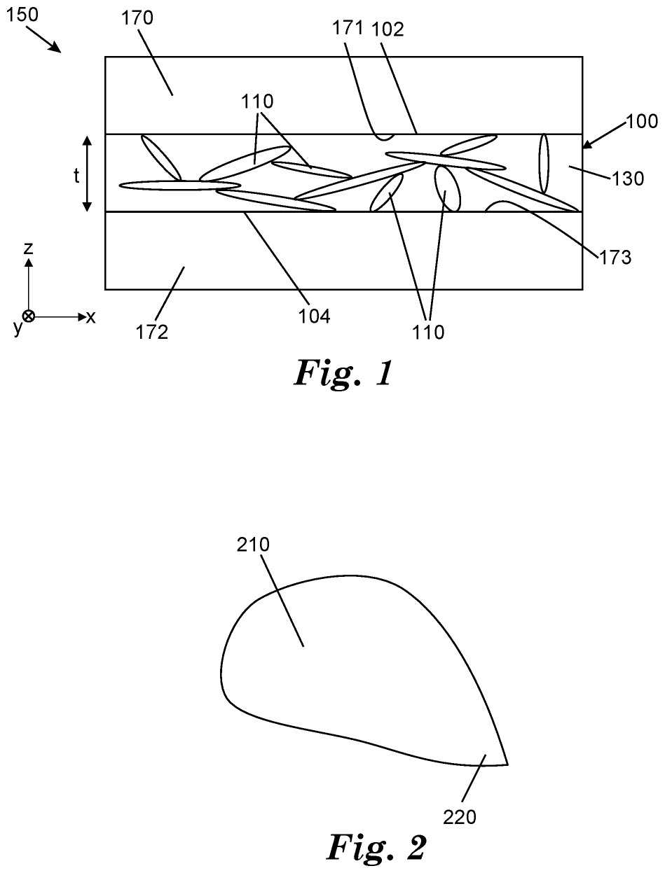

FIG. 1 is a schematic cross-sectional view of an article 150 including an electrically conductive adhesive layer 100 disposed between layers 170 and 172. Layers 170 and 172 may be adherends bonded through the adhesive layer 100, or one or both of layers 170 and 172 may be a release liner. In some embodiments, article 150 is an adhesive transfer tape and layer 170 is a first release liner releasably attached to a first major surface 102 of the adhesive layer 100. In some embodiments, layer 172 is a second release liner releasably attached to an opposite second major surface 104 of the adhesive layer 100. Any suitable release liner(s) may be used, such as, for example, a polyester (e.g., polyethylene terephthalate (PET)) film or a tape backing material (e.g., polyethylene coated paper). In embodiments where layers 170 and 172 are release liners, the major surfaces 171 and 173 of the layers 170 and 172, respectively, typically have a low surface energy so that adhesive layer 100 can be released from the layers 170 and 172. The low surface energy can be provided by a suitable surface treatment or coating as is known in the art. In some embodiments, the adhesive layer 100 has an average thickness tin a range of 10 micrometers to 100 micrometers, or 10 micrometers to 80 micrometers, or 10 micrometers to 60 micrometers, or 10 micrometers to 40 micrometers, for example.

The adhesive layer 100 includes a plurality of substantially plate-like nickel-coated graphite particles 110 dispersed uniformly in an adhesive material 130. In some embodiments, a ratio of a total weight of the nickel-coated graphite particles to a total weight of the adhesive layer is from 20% to 50%. Ratios may be expressed in terms of a fraction or the equivalent percentage. For example, a ratio of 0.4 is equivalent to a ratio of 40%. In some embodiments, the adhesive material at a sufficiently high concentration so that the adhesive layer has an electrical resistance in a thickness direction (z-direction) of less than 200 milli ohms. The adhesive layer 100 may have an electrical conductivity in the thickness direction (z-direction) of less than 200 milli ohms, or less than 150 milli ohms, or less than 100 milli ohms, or less than 50 milli ohms. The adhesive layer 100 may be more electrically conductive in the thickness direction (z-direction) and less electrically conductive in an in-plane direction (x- or y-direction).

In some embodiments, at least some of the substantially plate-like nickel-coated graphite particles have sharp features. FIG. 2 is a schematic top view of a substantially plate-like nickel-coated graphite particle 210 having a sharp feature 220. A particle is substantially plate-like when its thickness is significantly smaller than its length and width. For example, in some embodiments, the length and the width are each at least twice the thickness and at least one of the length and width is at least 3 times the thickness. In some embodiments, the length and the width are each at least 3 times the thickness and at least one of the length and width is at least 5 times the thickness.

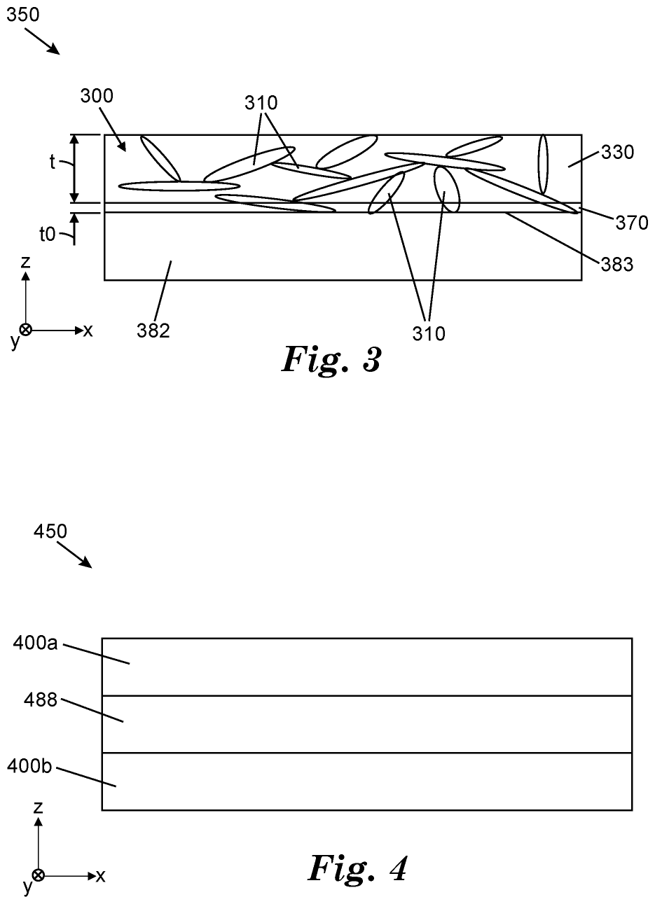

FIG. 3 is a schematic cross-sectional view of an electrical assembly 350 including an adhesive layer 330 having an average thickness tin a range from 10 microns to 100 microns and including an adhesive material 330; and a plurality of substantially plate-like nickel-coated graphite particles 310 dispersed uniformly in the adhesive material 330 at a sufficiently high concentration so that the adhesive layer 300 has an electrical resistance in a thickness direction of less than 200 milli ohms. At least some of the nickel-coated graphite particles are sufficiently sharp (e.g., as schematically illustrated in FIG. 2) such that when the electrically conductive adhesive layer 330 is adhered to a conductive surface 383 having an insulative layer 370 disposed thereon, where the insulative layer 370 has a thickness t0 in a range from 10 nm to 100 nm, at least some of the nickel-coated graphite particles 310 proximate the conductive surface 383 penetrate the insulative layer 370 to electrically connect with the conductive surface 383. In some embodiments, the conductive surface 383 is a metal surface (e.g., the layer 382 having the conductive surface 383 may be a metal layer such as a nickel layer or a stainless-steel layer). In some embodiments, the insulative layer 370 is an oxide layer. In some embodiments, the conductive surface 383 is or includes a metal and the insulative layer 370 is or includes an oxide of the metal.

FIG. 4 is a schematic cross-sectional view of a multilayer adhesive film 450 including a first electrically conductive adhesive layer 400a (e.g., corresponding to adhesive layer 100 or 300); a second electrically conductive adhesive layer 400b (e.g., corresponding to adhesive layer 100 or 300); and a conductive carrier layer 488 disposed between the first and second electrically conductive adhesive layers 400a and 400b. In some embodiments, the conductive carrier layer 488 is or includes at least one of a conductive fabric and a metal foil. For example, the conductive carrier layer may be a conductive fabric such as a conductive woven fabric, a conductive nonwoven fabric, or a conductive mesh fabric. The conductive fabric may include a plurality of metal-coated insulative fibers, for example. The adhesive material of the first and second electrically conductive adhesive layers 400a and 400b may penetrate through openings (e.g., between fibers in a fabric or through perforation in a metal foil) in the conductive carrier layer 488 to contact one another.

Embodiments described herein include the following.

Embodiment 1 is an electrically conductive adhesive layer having an average thickness in a range from 10 microns to 100 microns, and an electrical resistance in a thickness direction of less than 200 milli ohms, the adhesive layer comprising:

an adhesive material; and
a plurality of substantially plate-like nickel-coated graphite particles dispersed uniformly in the adhesive material, such that a ratio of a total weight of the graphite particles to a total weight of the adhesive layer is from 20% to 50%.

Embodiment 2 is the electrically conductive adhesive layer of Embodiment 1 having an average thickness in a range from 10 microns to 80 microns, or in a range from 10 microns to 60 microns, or in a range from 10 microns to 40 microns.

Embodiment 3 is the electrically conductive adhesive layer of Embodiment 1 or 2 being more electrically conductive in the thickness direction and less electrically conductive in an in-plane direction.

Embodiment 4 is the electrically conductive adhesive layer of any one of Embodiments 1 to 3 having an electrical resistance in the thickness direction of less than 150 milli ohms, or less than 100 milli ohms, or less than 50 milli ohms.

Embodiment 5 is the electrically conductive adhesive layer of any one of Embodiments 1 to 4, wherein the adhesive layer comprises one or more of a pressure sensitive adhesive, a hot melt adhesive, a thermoset adhesive, a thermoplastic adhesive, a UV adhesive, a liquid adhesive, a solvent based adhesive, and a water based adhesive.

Embodiment 6 is the electrically conductive adhesive layer of any one of Embodiments 1 to 5, wherein the adhesive layer comprises one or more of an acrylate, a methacrylate, an epoxy, a polyurethane, a polyester, a urethane, a polycarbonate, and polysiloxane.

Embodiment 7 is an adhesive transfer tape comprising:

the electrically conductive adhesive layer of any one of Embodiments 1 to 6; and
a first release liner releasably attached to a first major surface of the adhesive layer.

Embodiment 8 is a multilayer adhesive film comprising:

a first electrically conductive adhesive layer according to any one of Embodiments 1 to 6;
a second electrically conductive adhesive layer according to any one of Embodiments 1 to 6; and
a conductive carrier layer disposed between the first and second electrically conductive adhesive layers.

Embodiment 9 is the multilayer adhesive film of Embodiment 8, wherein the conductive carrier layer comprises at least one of a conductive fabric and a metal foil.

Embodiment 10 is the multilayer adhesive film of Embodiment 8, wherein the conductive carrier layer comprises a conductive fabric comprising a plurality of metal-coated insulative fibers.

Embodiment 11 is the multilayer adhesive film of Embodiment 9 or 10, wherein the conductive fabric is a woven fabric, a nonwoven fabric, or a mesh fabric.

Embodiment 12 is an electrically conductive adhesive layer having an average thickness in a range from 10 microns to 100 microns and comprising:

an adhesive material; and
a plurality of substantially plate-like nickel-coated graphite particles dispersed uniformly in the adhesive material at a sufficiently high concentration so that the adhesive layer has an electrical resistance in a thickness direction of less than 200 milli ohms, at least some of the nickel-coated graphite particles sufficiently sharp such that when the electrically conductive adhesive layer is adhered to a conductive surface comprising an insulative layer disposed thereon, the insulative layer having a thickness in a range from 10 nm to 100 nm, at least some of the nickel-coated graphite particles proximate the conductive surface penetrate the insulative layer to electrically connect with the conductive surface.

Embodiment 13 is the electrically conductive adhesive layer of Embodiment 12, wherein the conductive surface is a metal surface.

Embodiment 14 is the electrically conductive adhesive layer of Embodiment 12 or 13, wherein the insulative layer is an oxide layer.

Embodiment 15 is the electrically conductive adhesive layer of Embodiment 12, wherein the conductive surface comprises a metal and the insulative layer comprises an oxide of the metal.

Embodiment 16 is an electrical assembly comprising the electrically conductive adhesive layer of any one of Embodiments 1 to 6 or Embodiment 12 adhered to a metal surface comprising an oxide layer of the metal disposed thereon, the oxide layer having a thickness in a range from 10 nm to 100 nm, at least some of the nickel-coated graphite particles proximate the metal surface penetrating the oxide layer to electrically connect with the metal surface.

### Examples

Where not otherwise specified, materials were available from chemical supply houses, such as Aldrich, Milwaukee, Wis. Amounts are in parts by weight unless otherwise indicated.

Materials

| Trade Name or | | |
|---|---|---|
| Identifier | Description | Avialable from |
| Adhesive 1 | Acrylic solvent | Prepared by mixing an |
| | based adhesive | acrylic polymer in ethyl |
| | | acetate solvent to 30 wt % |
| | | to provide an intrinsic |
| | | viscosity of at least 1.0. |
| TP2040 | Terpene resin | Arizona Chemical |
| | | (Jacksonville, FL) |
| E-Fill 2806 | Nickel coated graphite | Oerlikon Metco |
| | | (Switzerland) |
| SC230F9.5 | Silver coated | Potters Industries, LLC |
| | copper flake | (Valley Forge, PA) |
| RD1054 | Bisamide type | 3M Company (St. Paul, |
| | crosslinker | MN) |
| Ethyl Acetate (EA) | Solvent | Peixing Chemical (China) |
| 120 g BKA C1S | Polycoated Kraft | Loparex Guangzhou |
| PCK Liner | Paper (PCK) liner | Naiheng Ltd. (China) |
| SILPHAN S 50 M | PET liner | Siliconature Co. (UK) |
| 3J13018 Clear | | |
| JX2203 | Conductive nonwoven | Shanghai Jiaxin Co., Ltd. |
| SHJX-B3035-01Y | Conduvtive fabric | Shanghai Jiaxin Co., Ltd. |

### Test Methods

### Resistance Test

The electrical resistance in the thickness direction of an adhesive layer was measured by cutting a tape containing the adhesive layer into two 10 mm×10 mm pieces and placing the pieces on the center of two spaced apart gold-plated copper electrodes of a first test board. After initial hand lamination and removal of the liners, a second test board having a gold-plated copper side was placed with the gold side down on the tape pieces with the board extending between the two tape pieces, and a 2 kg rubber roller was applied cross the first test board. After 20 minutes of dwell time at room temperature (about 22° C.), the direct current (DC) resistance between the electrodes was measured with a micro-ohm meter.

The resistance when laminated to stainless steel was tested similarly except that instead of the second test board having a gold-plated copper side, a stainless-steel test board having the same size and shape as the second test board was used.

### Peel Force Test

An adhesive film sample was laminated, with a one inch rubber roller and hand pressure of about 0.35 kilograms per square centimeter, to a 50 μm thick polyethylene terephthalate (PET) film. A one inch (25.4 cm) wide strip was cut from the adhesive film/PET laminate. This adhesive film side of the test strip was laminated, with a two kilogram rubber roller, to a stainless steel plate which had been cleaned by wiping it once with acetone and three times with heptane. The laminated test sample was allowed to remain at ambient conditions (about 22° C.) for about 20 minutes (20 min. dwell). The adhesive film sample/PET test sample was removed from the stainless-steel surface at an angle of 180 degrees at a rate of 30.5 centimeters per minute. The force was measured with an IMASS Model SP-2000 tester (IMASS, Inc., Accord, Va.). In some examples, the peel force was also determined after the laminated test sample was allowed to remain at ambient conditions for about 7 days (7 day dwell). In some examples, the peel force was measured from both sides of the adhesive layer (Side A and Side B).

### Preparation of Semi-Adhesive A

100 grams of Adhesive 1, 8.50 grams of TP2040 and 74.5 grams of Ethyl Acetate were mixed together to provide Semi-Adhesive A, which was an adhesive formulation having 21 percent solids.

### Examples 1-4 and Comparative Example C1-C2

Semi-adhesive A and RD1054 were weighted in a glass bottle and then the mixture was mechanically mixed by stirring blade until all the chemicals were well dispersed in the adhesive solution. Conductive particles were then added into the adhesive solution and mechanically mixed by stirring blade until all particles are well dispersed in the adhesive solution. The weight in grams of the components in the mixture are reported in Table 1.

The mixture with conductive particles was coated inside by comma bar hand spread coater onto a PET liner (SILPHAN S 50 M 3J13018 Clear). The coated conductive adhesive layer was dried in an oven at 110° C. for 10 min. A PCK liner (120 g BKA C1S PCK Liner) was then laminated to the dried adhesive film.

Comparative Example C1 utilized silver coated copper flake. The tape of Comparative Example C2 was 3M Electrically Conductive Adhesive Transfer Tape 9707 available from 3M Company.

Results are reported in Table 2.

TABLE 1

| | | | | | | Comp. |
|---|---|---|---|---|---|---|
| Type | Name | Example 1 | Example 2 | Example 3 | Example 4 | Ex. C1 |
| Adhesive | Semi-Adhesive A | 30 | 30 | 30 | 30 | 30 |
| Filler 1 | E-Fill 2806 | 2.7 | 3.2 | 4.9 | 4.9 | — |
| Filler 2 | SC230F9.5 | — | — | — | — | 4.9 |
| Crosslinker | RD1054 | 0.036 | 0.036 | 0.036 | 0.036 | 0.036 |

TABLE 2

| | | | | | Comp. | Comp. |
|---|---|---|---|---|---|---|
| | Ex. 1 | Ex. 2 | Ex. 3 | Ex. 4 | Ex. C1 | Ex. C2 |
| Filler loading (wt | 30.0 | 34.0 | 43.8 | 43.8 | 43.8 | N/A |
| % in dry film) | | | | | | |
| Thickness (μm) | 23 | 30 | 27 | 32 | 30 | 50 |
| Peel force (N/mm) | 0.17 | 0.60 | 0.52 | 0.54 | 0.63 | 0.69 |
| Side A, 20 min | | | | | | |
| dwell | | | | | | |
| Peel force (N/mm) | 0.45 | 0.98 | 0.69 | 0.78 | 1.18 | 1.02 |
| Side A, 7 day | | | | | | |
| dwell | | | | | | |
| Peel force (N/mm) | 0.43 | 0.67 | 0.57 | 0.61 | 1.13 | 0.65 |
| Side B, 20 min | | | | | | |
| dwell | | | | | | |
| Peel force (N/mm) | 0.59 | 1.12 | 0.72 | 0.87 | 1.22 | 0.95 |
| Side B, 7 day | | | | | | |
| dwell | | | | | | |
| Resistance in | 14 | 33 | 35 | 21 | 21 | 20 |
| thickness direction | | | | | | |
| (milli ohm) | | | | | | |
| Resistance on | 55 | 464 | 165 | 159 | 1316 | 1850 |
| stainless steel | | | | | | |
| (milli ohm) | | | | | | |

### Examples 5-10 and Comparative Example C3-C8

Adhesive layers on PET liners were prepared as generally described for Examples 1-4. Adhesive layers were laminated onto both sides of JX2203 conductive nonwoven or SHJX-B3035-01Y conductive fabric to make double side coated tapes (DCTs). Examples 5-10 and Comparative Example C3 and C6 were made using adhesive mixtures having components in grams given in Table 3. Examples 5-7 and Comparative Example C3 utilized the JX2203 conductive nonwoven between the two adhesive layers. Examples 8-10 and Comparative Example C6 utilized the SHJX-B3035-01Y conductive fabric between the two adhesive layers.

Comparative Example C4 was prepared by laminating 3M Electrically Conductive Adhesive Transfer Tape 9707, available from 3M Company, onto both sides of a JX2203 conductive nonwoven to make a conductive nonwoven based DCT.

The tape of Comparative Example C5 was 3M 9750 fabric-based conductive double-sided tape available from 3M Company.

Comparative Example C7 was prepared by laminating 3M Electrically Conductive Adhesive Transfer Tape 9707 onto both sides of SHJX-B3035-01Y conductive fabric to make conductive fabric based DCT.

The tape of Comparative Example C8 was 3M 7766-50 nonwoven-based conductive double coated tape available from 3M Company.

Results are reported in Tables 4-5.

TABLE 3

| | | Example 5 | Example 6 | Example 7 | Comp. Ex. |
|---|---|---|---|---|---|
| Type | Name | and 8 | and 9 | and 10 | C3 and C6 |
| Adhesive | Semi- | 30 | 30 | 30 | 30 |
| | Adhesive A | | | | |
| Filler 1 | E-Fill 2806 | 2.7 | 4.2 | 4.9 | — |
| Filler 2 | SC230F9.5 | — | — | — | 4.0 |
| Crosslinker | RD1054 | 0.036 | 0.036 | 0.036 | 0.036 |

TABLE 4

| | | | | Comp. | Comp. | Comp. |
|---|---|---|---|---|---|---|
| | Ex. 5 | Ex. 6 | Ex. 7 | Ex. C3 | Ex. C4 | Ex. C5 |
| Filler loading | 30.0 | 40.0 | 43.8 | 38.8 | — | — |
| (wt % in dry | | | | | | |
| film) | | | | | | |
| Thickness | 25 | 30 | 35 | 20 | 50 | — |
| (μm) | | | | | | |
| Peel force | 0.43 | 0.53 | 0.48 | 0.54 | 0.68 | 0.63 |
| (N/mm), 20 | | | | | | |
| min dwell | | | | | | |
| Resistance | 28 | 39 | 37 | 935 | 108 | 89 |
| in thickness | | | | | | |
| direction | | | | | | |
| (milli ohm) | | | | | | |

TABLE 5

| | | | | Comp. | Comp. | Comp. |
|---|---|---|---|---|---|---|
| | Ex. 8 | Ex. 9 | Ex. 10 | Ex. C6 | Ex. C7 | Ex. C8 |
| Filler loading | 30.0 | 40.0 | 43.8 | 38.8 | — | — |
| (wt % in dry | | | | | | |
| film) | | | | | | |
| Thickness | 25 | 30 | 35 | 20 | 50 | — |
| (μm) | | | | | | |
| Peel force | 0.45 | 0.51 | 0.50 | 0.57 | 0.72 | 0.59 |
| (N/mm), 20 | | | | | | |
| min dwell | | | | | | |
| Resistance | 31 | 37 | 33 | 701 | 378 | 76 |
| in thickness | | | | | | |
| direction | | | | | | |
| (milli ohm) | | | | | | |

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof

What is claimed is:

1. An electrically conductive adhesive layer having an average thickness in a range from 10 microns to 100 microns, and an electrical resistance in a thickness direction of less than 200 milli ohms, the adhesive layer comprising:
an adhesive material; and
a plurality of substantially plate-like nickel-coated graphite particles dispersed uniformly in the adhesive material, such that a ratio of a total weight of the graphite particles to a total weight of the adhesive layer is from 20% to 50%.

2. The electrically conductive adhesive layer of claim 1 having an average thickness in a range from 10 microns to 80 microns.

3. The electrically conductive adhesive layer of claim 1 having an average thickness in a range from 10 microns to 60 microns.

4. The electrically conductive adhesive layer of claim 1 having an average thickness in a range from 10 microns to 40 microns.

5. The electrically conductive adhesive layer of claim 1 being more electrically conductive in the thickness direction and less electrically conductive in an in-plane direction.

6. The electrically conductive adhesive layer of claim 1 having an electrical resistance in the thickness direction of less than 150 milli ohms.

7. The electrically conductive adhesive layer of claim 1 having an electrical resistance in the thickness direction of less than 100 milli ohms.

8. The electrically conductive adhesive layer of claim 1 having an electrical resistance in the thickness direction of less than 50 milli ohms.

9. The electrically conductive adhesive layer of claim 1, wherein the adhesive layer comprises one or more of a pressure sensitive adhesive, a hot melt adhesive, a thermoset adhesive, a thermoplastic adhesive, a UV adhesive, a liquid adhesive, a solvent based adhesive, and a water based adhesive.

10. The electrically conductive adhesive layer of claim 1, wherein the adhesive layer comprises one or more of an acrylate, a methacrylate, an epoxy, a polyurethane, a polyester, a urethane, a polycarbonate, and polysiloxane.

11. An electrical assembly comprising the electrically conductive adhesive layer of claim 1 adhered to a metal surface comprising an oxide layer of the metal disposed thereon, the oxide layer having a thickness in a range from 10 nm to 100 nm, at least some of the nickel-coated graphite particles proximate the metal surface penetrating the oxide layer to electrically connect with the metal surface.

12. An adhesive transfer tape comprising:
the electrically conductive adhesive layer of claim 1; and
a first release liner releasably attached to a first major surface of the adhesive layer.

13. A multilayer adhesive film comprising:
a first electrically conductive adhesive layer according to claim 1;
a second electrically conductive adhesive layer according to claim 1; and
a conductive carrier layer disposed between the first and second electrically conductive adhesive layers.

14. The multilayer adhesive film of claim 13, wherein the conductive carrier layer comprises at least one of a conductive fabric and a metal foil.

15. The multilayer adhesive film of claim 13, wherein the conductive carrier layer comprises a conductive fabric comprising a plurality of metal-coated insulative fibers.

16. The multilayer adhesive film of claim 15, wherein the conductive fabric is a woven fabric, a nonwoven fabric, or a mesh fabric.

17. An electrically conductive adhesive layer having an average thickness in a range from 10 microns to 100 microns and comprising:
an adhesive material; and
a plurality of substantially plate-like nickel-coated graphite particles dispersed uniformly in the adhesive material at a sufficiently high concentration so that the adhesive layer has an electrical resistance in a thickness direction of less than 200 milli ohms, at least some of the nickel-coated graphite particles sufficiently sharp such that when the electrically conductive adhesive layer is adhered to a conductive surface comprising an insulative layer disposed thereon, the insulative layer having a thickness in a range from 10 nm to 100 nm, at least some of the nickel-coated graphite particles proximate the conductive surface penetrate the insulative layer to electrically connect with the conductive surface.

18. The electrically conductive adhesive layer of claim 17, wherein the conductive surface is a metal surface.

19. The electrically conductive adhesive layer of claim 18, wherein the insulative layer is an oxide layer.

20. The electrically conductive adhesive layer of claim 19, wherein the conductive surface comprises a metal and the insulative layer comprises an oxide of the metal.
